(19) United States
(12) Patent Application Publication
(10) Pub. No.: US 2025/0052283 A1
(43) Pub. Date: Feb. 13, 2025

(54) PENDULUM ROCKER DAMPER WITH AN AXIS OF ROTATION FOR A DRIVE TRAIN

(71) Applicant: Schaeffler Technologies AG & Co. KG, Herzogenaurach (DE)

(72) Inventors: Andreas Dagenbach, Karlsruhe (DE); Olaf Werner, Bühl (DE); Yang Zhou, Ettlingen (DE); Mikhail Gvozdev, Bühl (DE)

(73) Assignee: Schaeffler Technologies AG & Co. KG, Herzogenaurach (DE)

(21) Appl. No.: 18/719,335

(22) PCT Filed: Nov. 30, 2022
(86) PCT No.: PCT/DE2022/100894

§ 371 Date: Jun. 13, 2024

(30) Foreign Application Priority Data
Jan. 12, 2022 (DE) 10 2022 100 596.8

(51) Int. Cl. F16D 3/12

(52) U.S. Cl. CPC F16D 3/12; F16D 2300/22

(57) ABSTRACT

A pendulum rocker damper includes an axis of rotation, a first outer connection, a primary side connected to the first outer connection, a second outer connection, a secondary side connected to the second outer connection, a rocker element, a rocker-side roller track, an outer roller track complementary to the rocker-side roller track, a roller arranged to roll on the roller tracks, and first and second energy storage elements. The first energy storage element is arranged to pretension the roller against the rocker-side roller track and the outer roller track. The second energy storage element is arranged in the roller, or in the rocker-side roller track or in the outer roller track, and arranged to pretension the roller against one of the rocker-side roller track or the outer roller track when the first energy storage element is in a resting position.

### CROSS-REFERENCE TO RELATED APPLICATIONS

This application is the United States National Phase of PCT Appln. No. PCT/DE2022/100894 filed Nov. 30, 2022, which claims priority to German Application No. DE102022100596.8 filed Jan. 12, 2022, the entire disclosures of which are incorporated by reference herein.

### TECHNICAL FIELD

The present disclosure relates to a pendulum rocker damper with an axis of rotation for a drive train, a drive train having such a pendulum rocker damper, and a motor vehicle having such a drive train.

### BACKGROUND

So-called pendulum rocker dampers are already known from the prior art. For example, concepts are known from DE 10 2019 121 204 A1 and DE 10 2019 121 205 A1 for modulating the rigidity of a rotating shaft or a rotating shaft system in a drive train. These pendulum rocker dampers comprise an input side and an output side which are connected to one another (in both directions) in a torque-transmitting manner. A plurality of rocker elements (also referred to as rockers) and a plurality of energy storage elements are interposed. The rocker elements are supported in a relatively displaceable manner by means of at least one rolling element on the input side and/or on the output side. The rolling elements are clamped between the respective transmission track and complementary mating track by means of the spring elements purely such that they can roll and are therefore referred to as rollers. By means of this pendulum rocker damper, the relative torsion angle between the input side and the output side is converted into a spring deflection of the energy storage elements. By means of the transmission tracks and the complementary mating tracks, which form a ramp gear and are also referred to as roller tracks, a transmission ratio can be set and thus the stiffness of the pendulum rocker damper can be adjusted. It is also advantageous here that the transmission ratio need not be constant, but rather the gradient of the ramp gear can be variably adjusted via the torsion angle of the input side to the output side.

In order to be able to realize the desired characteristic curve of the pendulum rocker damper under all boundary conditions, it must be ensured that the rollers are in the position defined for them at all times. This can only be achieved if the necessary roller movements relative to the adjacent contact partners, i.e., the rocker elements and primary side, as well as the secondary side or their roller tracks, are carried out exclusively by means of a rolling movement (i.e., without superimposed slippage). For this reason, significant sliding movements and a complete temporary loss of contact force between the rollers and roller tracks must be avoided under all circumstances. If this cannot be ensured, there is also a risk of additional noise caused by the unwanted roller movement and greatly increased wear of the rollers and their contact surfaces on the roller tracks. It has been shown that during operation at a minimum torsion angle or at a low torque level, i.e., when the rollers are in their resting position, there can be play and thus rattling may occur. When used in a motor vehicle, this rattling is perceived by a vehicle occupant as a negative acoustic effect (so-called noise vibration harshness).

The pendulum rocker damper has internal vibration modes. In principle, the at least one rocker element can be brought into resonance by the external excitation in this regard. Given a plurality of rocker elements, these can vibrate both in phase with one another or against one another. In this context, the natural frequencies of the system are determined by at least the first energy storage element, but above all also by the contact stiffness and component stiffness. At low load, the lowest in-phase mode is in a frequency range from 15 Hz to 40 Hz. In a motor vehicle, excitation can therefore occur during driving operation. The vibrations lead to a modulation of the contact forces on the rollers. If the modulation is greater than the static pretension applied, the rollers will lift off, causing the aforementioned problems.

### SUMMARY

The present disclosure relates to a pendulum rocker damper with an axis of rotation for a drive train, having at least the following components:
a primary side that is connected in a torque-transmitting manner to a first outer connection:
at least one rocker element;
at least one first energy storage element for exerting a first pretensioning force;
at least one roller; and
a secondary side that is connected in a torque-transmitting manner to a second outer connection.

The at least one roller is mounted such that it can roll on a rocker-side roller track and an outer roller track that is complementary to the rocker-side roller track and is pretensioned against the roller tracks by means of the first pretensioning force of the at least one first energy storage element.

The at least one second energy storage element may be provided in the roller or in at least one of the roller tracks for exerting a second pretensioning force, and the roller is pretensioned against at least one of the roller tracks, perpendicular to the track, by means of the second pretensioning force, at least in the resting position of the first energy storage element.

In the following, reference is being made to the stated axis of rotation when the axial direction, radial direction or the direction of rotation and corresponding terms are used, unless explicitly stated otherwise. Unless explicitly stated otherwise, ordinal numbers used in the preceding and subsequent description are used only for the purposes of clear distinction and do not indicate an order or a ranking of designated components. An ordinal number greater than one does not necessarily mean that a further such component must be present.

The pendulum rocker damper is configured to modulate a torque within the drive train. The torque to be transmitted is aligned around the axis of rotation during operation. In this regard, the pendulum rocker damper is balanced (e.g., in a rotationally symmetrical manner) with respect to this axis of rotation.

Furthermore, the pendulum rocker damper includes a primary side that is connected in a torque-transmitting manner to the first outer connection, and a secondary side that is connected in a torque-transmitting manner to the second outer connection. The primary side and/or the secondary side may be formed from sheet metal in the form of discs or disc segments, e.g., by stamping and/or sheet metal forming.

In order to modulate a torque, the pendulum rocker damper includes at least one rocker element and at least one first energy storage element, which is configured to exert the first pretensioning force. The rocker element is mounted by means of at least one or more (e.g., two or three) rollers on the primary side and/or the secondary side so that it can be pivoted, i.e., rocked, relative to the direction of rotation (or superimposed on the direction of rotation). Two energy storage elements and two rocker elements may be provided.

If two or more rocker elements are provided, the at least one energy storage element may be provided between two rocker elements, and a rocking movement of the two rocker elements results in a relative movement of the two rocker elements in relation to one another. The relative movement in turn results in a change in the energy potential of the at least one energy storage element. If two rocker elements are provided, one or two energy storage elements may be provided, which may be arranged at opposite ends of the rocker elements in each case. If three rocker elements are provided, three energy storage elements may be provided. If only one rocker element is provided, the energy storage element may be arranged between the rocker element and either the secondary side or the primary side, so that the energy potential of the energy storage element changes during a relative movement between the rocker element and the secondary side or the primary side resulting from the rocking movement.

In this regard, the at least one roller is arranged on the rocker-side roller track and the complementary outer roller track in such a way that, during operation, it is in a resting position within the roller tracks without torque applied and is mounted within the roller tracks such that it can roll. The at least one roller is pretensioned against the roller track by means of the at least one energy storage element or by the first pretensioning force exerted by it, thus forming a ramp gear.

The roller tracks have a gradient which is selected in such a way that additional (kinetic) energy or work is required in order to overcome the gradients. The required (kinetic) energy can be achieved by reducing a torsional vibration or the torque to be modulated. For example, by means of the gradient of the roller tracks and/or the stiffness of the energy storage element, consequently the absolute value of the first pretensioning force, a stiffness or damping value can be defined or adjusted. This allows for a modulated torque transmission from the primary side to the secondary side or vice versa. The at least one energy storage element is, for example, a helical compression spring. for example with a straight spring axis, a bow spring or a gas pressure accumulator. The energy storage element can be expanded or compressed by a movement of the primary side and the secondary side relative to one another.

In an example embodiment, the pendulum rocker damper includes at least a second energy storage element, and the second energy storage element is configured to exert a second pretensioning force. The second pretensioning force is oriented in such a way that the at least one roller is pretensioned perpendicular to the track against at least one of the roller tracks. It should be noted that the roller forms a contact (in the form of a line, for example) with the respective roller track. A line through the roller center of the respective roller and the contact is perpendicular to the track. A line orthogonal to this is tangential to the track. Since the applied torque is to be transmitted or supported by the rollers, there is a resulting force component of all rollers in the tangential direction.

In one embodiment, the second energy storage element is formed by means of a specifically adjusted material stiffness, a solid spring, a compression spring, a tension spring or a lever spring. The second energy storage element is, for example, supported radially on the outside (in relation to the axis of rotation of the pendulum rocker damper) and connected to the at least one roller in a force-transmitting manner radially on the inside. Alternatively, the second energy storage element is, for example, supported radially on the inside and connected to the at least one roller in a force-transmitting manner radially on the outside. Thus, the at least one roller is radially pretensioned against the corresponding radially inner and/or radially outer roller track. In an example embodiment, the at least one roller is pretensioned by the second energy storage element, which is designed for example as a spring plate, from radially on the inside against the radially outer roller track (or vice versa).

Component tolerances can lead to a reduction in the pretensioning, which further exacerbates the problem. In one embodiment, the roller therefore is overdimensioned so that this results in a targeted second pretensioning force, for example taking into account the extremes due to manufacturing tolerances.

This at least one second energy storage element compensates for the fact that in the resting position (also referred to as the neutral position) the force of the first energy storage element is minimal and thus the tendency to rattle is maximized. A minimum pretensioning force is ensured by means of the second energy storage element. This opens up the possibility of designing a first energy storage element in such a way that the first pretensioning force is low in the resting position, so low in fact that a pretensioning force on the roller is too low as a result of design-related or tolerance-related play to suppress rattling. By means of the second energy storage element, this can always be ensured by simple means, regardless of the design of the first pretensioning force. A tolerance compensation can thus be achieved so that the pretensioning losses are minimized in tolerance-related situations.

According to a further aspect, a natural frequency of the pendulum rocker damper, and of the freely movable rocker element, for example, can be changed by means of the second energy storage element. It is proposed here to introduce targeted elasticities into the system in the relevant load range by means of the second energy storage element. The elasticities shift the problematic natural frequencies to low frequencies so that they can no longer be excited during operation. The result is that a robust function can be achieved, also with respect to dynamics under all tolerance conditions. This is exemplarily confirmed in the simulation, the graph of which is shown in FIG. 2 (compared to FIG. 3).

It should be noted that in one embodiment, the second pretensioning force is oriented solely perpendicular to the track. This pretensions the roller (at least in the resting position) perpendicularly to the track onto the corresponding roller track. Alternatively or in addition, the second pretensioning force includes a force component tangential to the track in addition to the force component perpendicular to the track. The second pretensioning force never solely comprises a force component tangential to the track.

In a first embodiment, one roller or a plurality of rollers within the pendulum rocker damper are spring-loaded relative to one or both contact partners. In a second embodiment, the radius of the rollers and/or the shape of the relevant roller track are selected such that a defined second pretensioning force is generated within the contacts. In a third embodiment, the resulting spring stiffness and pretension are selected such that expected tolerances in combination with expected dynamic relative movements between rollers and contact partners cannot lead to a disappearance of the contact forces. In a fourth embodiment, the resulting spring stiffness is selected such that the resulting resonances cannot be excited in the driving range. In a fifth embodiment, the change in the characteristic curve of the stiffness caused by the spring-loading is taken into account in the design. In one embodiment, at least two of the aforementioned properties are combined.

It is further proposed in an example embodiment of the pendulum rocker damper that a second pretensioning force is exerted on the associated roller by means of at least one roller track, and the roller track may have a stiffer material than the second energy storage element.

It is proposed here that the second energy storage element is formed by the (relevant) roller track itself and thus the second pretensioning force is exerted by the roller track itself on the associated roller. In one embodiment, a separate spring element is introduced between the respective element (rocker element, primary side or secondary side) and the roller track. Alternatively, the roller track itself is made of a material with a suitable (low) stiffness. In one embodiment, the roller track is formed from a separate material which is connected to the base body of the respective element, for example a plastic (such as polyamide [PA]), which may be connected to the base body by means of injection molding.

In an example embodiment, the roller track itself is, in this regard, formed from a stiffer material than the second energy storage element, so that the roller is prevented from sinking into the roller track. When the roller sinks into the roller track, a hurdle is created which the roller must first overcome. In many cases, this is undesirable in order to avoid slippage. In one embodiment, the roller track is hardened (and the roller or its surface is not).

It is further proposed in an example embodiment of the pendulum rocker damper that the rocker element is supported on the primary side and on the secondary side by means of at least one roller in each case, and the second energy storage element is arranged between the rocker-side roller tracks in order to exert the second pretensioning force on the at least two rollers in each case.

It is proposed here that a second energy storage element is provided for both rocker-side roller tracks. In this regard, this second energy storage element is arranged centrally in the rocker element, for example, so that the rocker element is pushed apart and thus presses with its (rocker-side) roller tracks against the two rollers, i.e., against the primary side and against the secondary side. Such a second energy storage element is, for example, a helical compression spring or a leaf spring.

It is further proposed in an example embodiment of the pendulum rocker damper that the second pretensioning force of the second energy storage element has a spring stiffness that is variable depending on a torsion angle between the primary side and the secondary side.

It is proposed here that the spring stiffness is dependent on a torsion angle (between the primary side and the secondary side) so that the second pretensioning force is not constant over the entire torsion angle. For example, the second pretensioning force is variable in that a corresponding spring element is brought to a stop, for example a leaf spring. For example, a second pretensioning force is variable in that the second energy storage element is only arranged to act on the rollers or the roller track in regions. For example, the second pretensioning force is variable in that the second energy storage element has a locally dependent (variable) stiffness, and the second energy storage element is then arranged on the roller track side, for example, and is composed, for example, of a plurality of individual spring elements. Alternatively, for example, a locally dependent stiffness of the second energy storage element is created by using a curved leaf spring (clamped on both sides), which has a maximum spring deflection in its maximum extension out of the associated roller track and has a smaller spring deflection outside of this maximum curvature and is thus brought to a stop earlier compared to the maximum curvature.

In one embodiment, the second energy storage element is designed as a cantilever, e.g., made of a spring plate, and the cantilever, in addition to its variable spring action depending on the position on the cantilever, may also act in a locally limited manner on the roller or roller track.

In one embodiment, the second energy storage element is designed as a cantilever made of a spring plate and configured in such a way that it derives the spring stiffness required for the second pretensioning force from a bending deformation of a cantilever. In this regard, the spring stiffness is indicative of the ratio of the force acting on a spring plate (in this case the second pretensioning force) to the resulting deflection of the spring plate. The spring stiffness of the second energy storage element is, in this regard, designed in such a way that it has a predetermined spring stiffness in the direction of the second pretensioning force.

The cantilever may be inserted or oriented in such a way that at a torsion angle (between the primary side and the secondary side) not equal to zero, i.e., when the first pretensioning force of the at least one first energy storage element is increased, the second pretensioning force is reduced. Conversely, the first pretensioning force, which decreases towards the resting position, can at least be sufficiently compensated for. This means that the at least one roller is always pretensioned against a corresponding roller track during operation.

It is further proposed in an example embodiment of the pendulum rocker damper that at least one of the second energy storage elements includes one of the rollers, and each of the rollers may include one of the second energy storage elements.

In this embodiment, at least one of the rollers itself has the second energy storage element, and this is formed, for example, around the circumference, for example as a plastic coating or as individual elements extending radially from a roller center. The individual elements may be designed with different spring stiffnesses and/or different maximum spring deflection lengths so that a stiffness dependent on the torsion angle between the primary side and the secondary side can also be reflected here.

It is further proposed in an example embodiment of the pendulum rocker damper that at least one of the second energy storage elements is arranged to exert the second pretensioning force in a locally limited manner on the associated roller.

In this embodiment (as already explained above in another context), a dependency of the second pretensioning force on the torsion angle between the primary side and the secondary side is created by the second energy storage element acting on the respective roller solely in a locally limited manner. For example, the second energy storage element is configured in such a way that it is arranged with its second pretensioning force acting on the respective roller only in or in the region of the resting position. Outside of the resting position or outside of a region of the resting position, no second pretensioning force acts on the roller. For this purpose, the second energy storage element is integrated into the respective roller track or is a separate element that acts on the respective roller parallel to the roller track.

It should be noted that there is not generally no pretensioning force acting on a roller if it is outside of the locally limited zone. Rather, only the pretensioning force originating from the second energy storage element is no longer effective or at least negligible compared to other applied forces.

Furthermore, in an example embodiment of the pendulum rocker damper, it is proposed that the rocker element includes an additional mass for shifting its center of gravity.

An asymmetrical application of force or support or an unfavorable position of the center of gravity of a rocker element amplify resonant vibrations.

It is proposed here that the rocker element includes an additional mass. This additional mass is, for example, a separately attached mass and/or the rocker element is shaped in a corresponding manner. This additional mass is therefore not necessarily recognizable as such. Rather, the additional mass is a mass which is superfluous for the other tasks of the rocker element, i.e., the transmission of force and the provision of the roller tracks and stops with respect to the at least one first energy storage element. The intended purpose of such an additional mass is to shift the center of gravity of the rocker element in such a way that the natural frequency of the rocker element in its suspension in the pendulum rocker damper is changed. Shifting the center of gravity of the rocker element changes the dynamic inertia (Steiner's theorem) and thus the natural frequency of the system.

In order to reduce the tilting component of the rocker element in the relevant vibration mode, the center of gravity of the rocker element is brought to an optimal point in relation to the force application points by means of the additional mass.

According to a further aspect, a drive train is proposed, having at least the following components:
at least one drive machine for outputting a torque;
at least one consumer for receiving a torque;
a transmission for transmitting a torque between the at least one drive machine and a consumer; and
a pendulum rocker damper according to an embodiment as described above.

A torque can be transmitted in a modulated manner between the at least one drive machine and the consumer by means of the pendulum rocker damper.

The drive train proposed here includes a first drive machine, for example an internal combustion engine with an internal combustion engine shaft and a transmission for transmitting torque between the internal combustion engine shaft and a consumer, for example the drive wheels in a motor vehicle. By means of the pendulum rocker damper, which is designed according to an embodiment as described above, the torque transmission between the internal combustion engine and the consumer can be implemented. A torque transmission between the consumer and the internal combustion engine shaft may be possible in both directions, for example in a motor vehicle for accelerating the motor vehicle (traction mode) and in the opposite direction (overrun mode), for example to use the engine brake to decelerate the motor vehicle or to recuperate this deceleration energy.

In an example embodiment of the drive train, an electric drive machine with a rotor shaft is also connected to the torque flow on the output side of the pendulum rocker damper and upstream of the consumer. For example, when the clutch is disengaged, the consumers can operate purely electrically. In one embodiment, the electric drive machine and the clutch (with or without the pendulum rocker damper) together form what is termed a hybrid module, which can be easily integrated into the drive train as a structural unit.

With the drive train proposed here, which includes the pendulum rocker damper described above, a reduction of torsional vibrations and disruptive acoustic noise can be achieved within the internal combustion engine and the transmission or the pendulum rocker damper. A roller may be further safely prevented from sliding by ensuring a minimum pretension and shifting the natural frequency into non-critical ranges, even under dynamic conditions.

According to a further aspect, a motor vehicle is proposed, having a drive train in accordance with an embodiment according to the above description and at least one drive wheel, and the at least one drive wheel can be driven by means of the drive train in order to propel the motor vehicle.

The installation space is small in motor vehicles due to the increasing number of components and it is therefore advantageous to use a small-sized drive train. With the desired what is termed downsizing of the drive machine and simultaneous reduction in operating speeds, the intensity of the disruptive torsional vibrations is increased. A similar problem arises with what is termed hybridization, in which an electric drive machine is used more and more frequently or even forms the main source of torque and a small internal combustion engine is to be used, which, however, must be connected and disconnected again from the drive train more frequently. It is therefore a challenge to provide a sufficient equalization of rotational irregularities with simultaneously low parts costs and little available installation space.

This problem is exacerbated in the case of passenger cars in the small car category according to European classification. The assemblies used in a passenger car of the small car category are not significantly reduced in size relative to passenger cars of larger car categories. Nevertheless, the available installation space for small cars is considerably smaller.

In the motor vehicle proposed here, the drive train of which includes the pendulum rocker damper described above, a reduction of torsional vibrations and disruptive acoustic noise can be achieved within the internal combustion engine and the transmission or the pendulum rocker damper. A roller may be further safely prevented from sliding by ensuring a minimum pretension and shifting the natural frequency into non-critical ranges, even under dynamic conditions.

Passenger cars are assigned to a vehicle category according to, for example, size, price, weight, and performance, wherein this definition is subject to constant change based on the needs of the market. In the US market, vehicles in the small car and minicar categories according to European classification are assigned to the subcompact car category, while in the British market they correspond to the super mini and city car categories respectively. Examples of the minicar category are the Volkswagen up! or Renault Twingo. Examples of the small car category are the Audi A1, Volkswagen Polo, Opel Corsa or Renault Clio. Known hybrid vehicles are the BMW 330e or the Toyota Yaris Hybrid. Known mild hybrids are, for example, the Audi A6 50 TFSI e or BMW X2 xDrive25e.

### BRIEF DESCRIPTION OF THE DRAWINGS

The present disclosure is explained in detail below against the relevant technical background with reference to the associated drawings, which show example embodiment. The disclosure is in no way restricted by the purely schematic drawings, and it should be noted that the drawings are not dimensionally accurate and are not suitable for defining proportions. In the drawings:

FIG. 1 shows a schematic front view of a pendulum rocker damper around an axis of rotation:

FIG. 2 shows a diagram of the transmission behavior of the components in an ideal pendulum rocker damper;

FIG. 3 shows a diagram of the transmission behavior of the components in a real pendulum rocker damper without a second energy storage element;

FIG. 4 shows a diagram of the transmission behavior of the components in a real pendulum rocker damper with a second energy storage element;

FIG. 5 shows a detailed view of the pendulum rocker damper with a second energy storage element according to FIG. 1;

FIG. 6 shows a schematic diagram of the roller tracks of a pendulum rocker damper in an embodiment with a stiff roller track;

FIG. 7 shows a schematic diagram of the roller tracks of a pendulum rocker damper in an embodiment with a central second energy storage element in a rocker element;

FIG. 8 shows a schematic diagram of the roller tracks of a pendulum rocker damper in an embodiment with a soft roller track;

FIG. 9 shows a schematic diagram of the roller tracks of a pendulum rocker damper in an embodiment with a roller pretensioned in a locally limited manner;

FIG. 10 shows a schematic diagram of a roller with a second energy storage element between the roller tracks of a pendulum rocker damper;

FIG. 11 shows a schematic diagram of a roller with a second energy storage element between the roller tracks of a pendulum rocker damper in an alternative embodiment; and

FIG. 12 shows a top view of a motor vehicle with a drive train.

### DETAILED DESCRIPTION

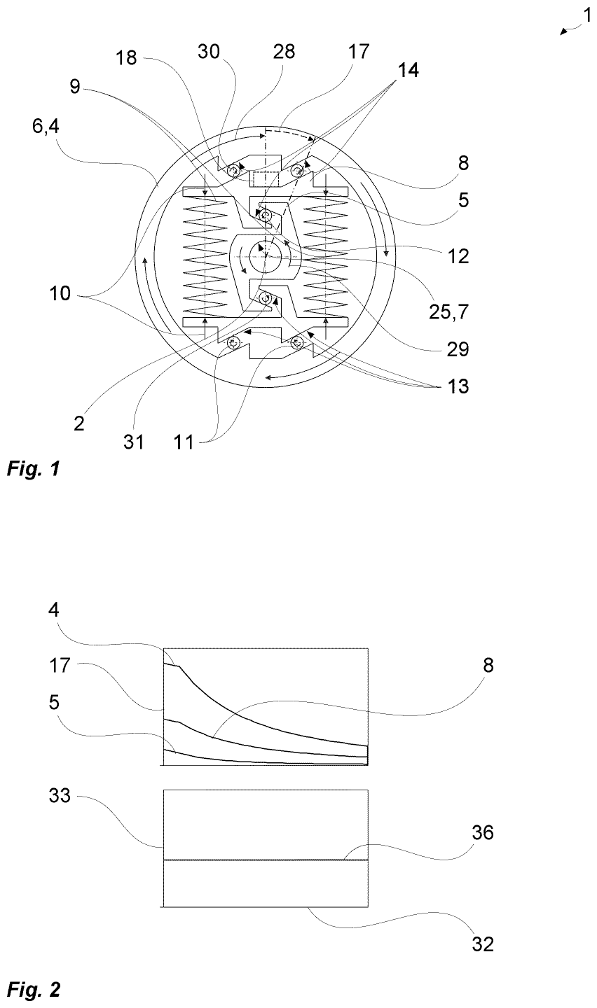

FIG. 1 shows a schematic front view of a pendulum rocker damper 1 about an axis of rotation 2. It should be noted that not all components of the pendulum rocker damper 1 are provided with a reference sign and, pars pro toto, in some cases only one of several identical elements is provided with a reference sign. As shown, the axis of rotation 2 extends into the image plane and coaxially to a secondary outer connection 7 that is connected to a secondary side 5 in a torque-proof manner and to a primary outer connection 6 that is connected to a primary side 4 in a torque-proof manner. In this exemplary embodiment, the secondary outer connection 7 is designed, for example, as a hub 25 of a shaft-hub connection and is configured, for example, to receive a machine shaft 26,27 (ref. FIG. 12). The primary side 4 is designed, for example, as the clutch disc or is connected to a primary mass (also referred to as a flywheel) as a main damper.

Two rocker elements 8 are arranged axially outside of the secondary side 5 and connected in a torque-transmitting manner to the secondary side 5. The rocker elements 8 are pretensioned in a resting position by means of two first energy storage elements 9. The rocker elements 8 are supported such that they can roll in a torque-transmitting manner by means of (here purely optionally two, in each case) primary rollers 11 on a primary side 4 and one (here purely optionally a single) secondary roller 12 on the secondary side 5. In this regard, the primary side 4 and the secondary side 5 form outer roller tracks 14 and the rocker elements 8 form complementary rocker-side roller tracks 13. In addition, the upper one of the rocker elements 8 as shown includes (purely optionally) an additional mass 18, which is configured to shift the center of gravity of the rocker element 8. Thus, the torque transmission from the secondary side 5 to the primary side 4 and vice versa can be implemented by means of the rollers 11,12 and the rocker elements 8.

With a first relative direction of rotation 28 of the primary side 4 and a second relative direction of rotation 29, i.e., with a resulting relative torsion angle 17 between the primary side 4 and the secondary side 5, the primary rollers 11, describing a first roller direction of rotation 30, and the secondary roller 12, describing a second roller direction of rotation 31, roll on the associated rocker element 8. The roller tracks 13,14 are designed in a ramp-like manner in order to convert this torsion between the primary side 4 and the secondary side 5 into a compression of the (first) energy storage elements 9. Namely, the roller tracks 13,14 are designed in such a way that they form a ramp gear in interaction with the (corresponding to the number of rocker elements 8; here two) first energy storage elements 9, which here are each designed purely optionally as a helical compression spring with a straight spring axis. By means of this ramp gear and the spring stiffness of the energy storage elements 9, a torque can be modulated via a correspondingly shaped ramp gradient over a torsion angle 17. For example, a high stiffness can be set at the beginning and at the end (i.e., at the maximum torsion angle 17) and a lower torsional stiffness in between.

When the two energy storage elements 9 are compressed, a first pretensioning force 10 (here along the line of action of the helical compression springs) on the rocker elements 8 is increased. The pendulum rocker damper 1, and particularly visibly its rocker elements 8, is/are moved out of the resting position (shown here) in the process. The rollers 11,12 are simultaneously pretensioned against the roller tracks 13,14 by the first pretensioning force 10 of the first energy storage elements 9 so that they cannot slip due to an applied torque on the roller tracks 13,14 and roll. A torque stiffness or damping value dependent on the torsion angle is set by means of the gradient of the roller tracks 13,14 and/or the stiffness of the first energy storage element 9, and thus the absolute value of the first pretensioning force 10. This allows for a modulated torque transmission from the primary side 4 to the secondary side 5 or vice versa.

FIG. 2 is a diagram of the transmission behavior of the components in an ideal pendulum rocker damper 1. In the diagrams shown here, the abscissa is the excitation frequency 32 (increasing to the right). In the upper diagram, the torsion angle 17 is plotted on the ordinate, i.e., the amplitude of the movement of the respective component. In the lower diagram, the (pretensioning) force 33 acting on the (respective) roller 11,12 is plotted on the ordinate. In the upper diagram, the torsion angle 17 as a result of excitation with the respective excitation frequency 32 of the primary side 4 (top line), the rocker element 8 (middle line) and the secondary side 5 (bottom line) is plotted. These components are maximally excited at low excitation frequencies 32, for example with a torsion angle 17 of up to 2° [two degrees out of 360°], and approach a position at rest with increasing frequency.

In the lower diagram, the (pretensioning) force 33 transmitted to the roller 11,12 is constant over the excitation frequency 32 and is greater than zero. In the ideal state, the roller 11,12 therefore does not lift off at any excitation frequency 32.

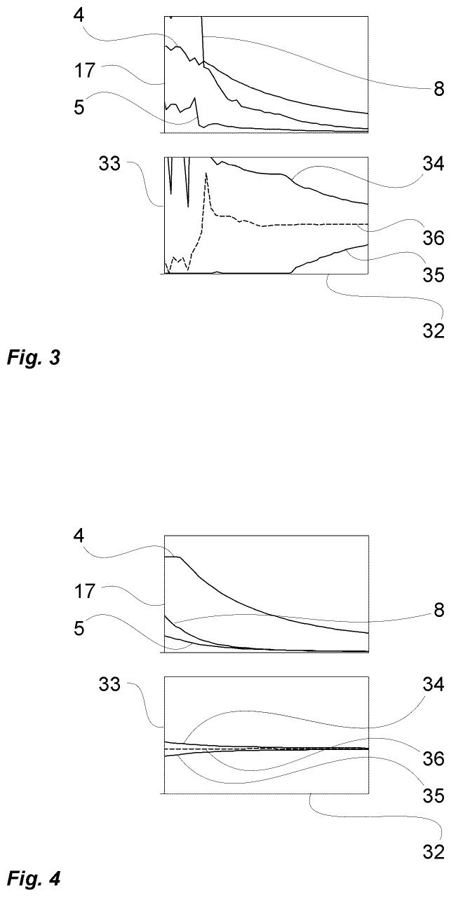

FIG. 3 shows a diagram of the transmission behavior of the components in a real pendulum rocker damper 1 without a second energy storage element 15. Compared to the diagrams shown in FIG. 2, an excess frequency rise is observed at the rocker element 8 because it is brought into resonance (the curve leaves the section shown, and, for example, the section shown includes the maximum torsion angle 17).

In the lower (force 33) diagram, it can be seen that the (pretensioning) force 33 on the roller 11,12 fluctuates greatly as a result of the vibration of the rocker element 8. An upper envelope (upper contact force 34) and a lower envelope (lower contact force 35) as well as an average value of the contact force 36 (shown dashed) of the rollers 11,12 are shown. Above all, a value of zero is reached as an extreme value of the lower contact force 35. It is therefore possible that the relevant roller 11,12 will lift off.

FIG. 4 shows a diagram of the transmission behavior of the components in a real pendulum rocker damper 1 with a second energy storage element 15. Here, almost the same amplitude response is achieved on the rocker element 8 (and the other elements) as in FIG. 2 in the ideal state. An excess frequency rise cannot be observed.

In the lower (force 33) diagram, it can be seen that the (pretensioning) force 33 on the roller 11,12 only fluctuates slightly around a constant average value in the lower frequency range (between the upper and lower envelope) as a result of the vibration of the rocker element 8. A (low) extreme value of the lower contact force 35 does not reach the value of zero. It is therefore not possible that the relevant roller 11,12 will lift off.

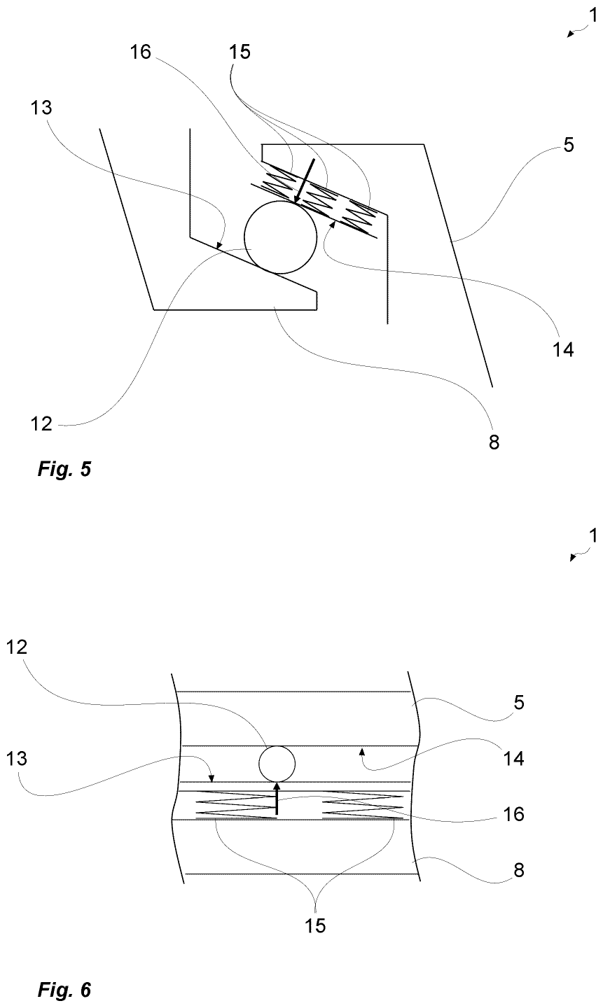

FIG. 5 shows a detailed view of the pendulum rocker damper 1 with a second energy storage element 15 according to FIG. 1. This detailed view shows a component of the ramp gear between the secondary side 5 and one of the rocker elements 8. Nevertheless, the principle shown can also be applied to the primary side 4 and a rocker element 8. When the pendulum rocker damper 1 is in the resting position shown, i.e., at a torsion angle 17 of 0° [zero degrees out of 360°]. the first pretensioning force 10 is minimal, so that the rollers 11,12 within the pendulum rocker damper 1 can tend to lift off. The lifting of the rollers 11,12 results, for example, from a tolerance-related play and/or an insufficient first pretensioning force 10 of the (first) energy storage elements 9. In order to prevent lift-off in the resting position, a second energy storage element 15 is arranged (purely optionally here) on the secondary side 5, and the second energy storage element 15 is firmly connected to the secondary side 5 at one end and forms the outer roller track 14 at the opposite end. The second energy storage element 15 is portrayed in this schematic arrangement as a plurality of compression springs. The resulting second pretensioning force 16 is oriented in such a way that, in the resting position of the pendulum rocker damper 1, it pretensions the secondary roller 12 on the rocker-side roller track 13, perpendicular to the track, thus preventing a lift-off.

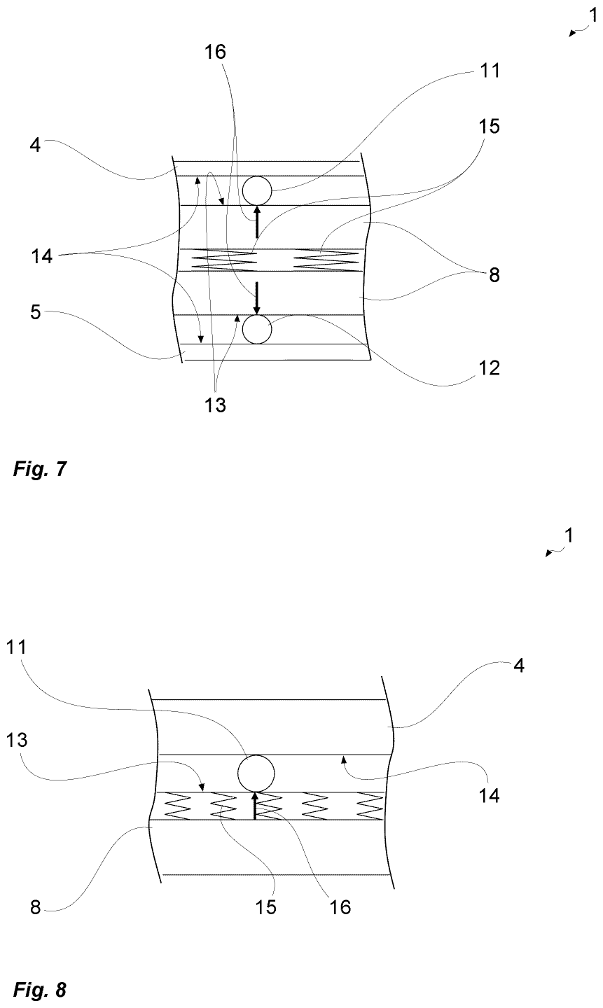

It should be noted that this exemplary embodiment (as well as the following exemplary embodiments according to FIGS. 6 to 7) can also be applied to a primary roller 11, and (as far as applicable to the other exemplary embodiments) the second energy storage element 15 can be arranged in the rocker-side roller track 13 and/or in both roller tracks 13,14 (assigned to a roller 11,12). Furthermore, it should be noted that in one embodiment, the second energy storage element 15 is formed by a coating of a material with a different elasticity than that of the base body of the rocker element 8 or the primary side 4 or the secondary side 5; alternatively or in addition, for example, by a leaf spring.

FIG. 6 shows a schematic diagram of the roller tracks 13,14 of a pendulum rocker damper 1 (for example according to FIG. 1) in an embodiment with a stiff roller track 13,14. In contrast to the exemplary embodiment shown in FIG. 5, the rocker-side roller track 13 is formed by a separate rigid element. The second pretensioning force 16 applied to the roller 12 by means of the second energy storage element 15 (represented here by two compression springs) is initially transmitted to the rocker-side roller track 13 in this exemplary embodiment. Due to the stiffness of the rigid rocker-side roller track 13, the second pretensioning force 16 is applied to the roller 12 evenly over the rolling path under consideration. In this way, the second pretensioning force 16 is applied to the roller 12 perpendicular to the track even outside of the resting position of the pendulum rocker damper 1, and the roller 12 is prevented from sinking into the roller track 13 without requiring additional installation space.

FIG. 7 shows a schematic diagram of the roller tracks 13,14 of a pendulum rocker damper 1 (for example according to FIG. 1) in an embodiment with a central second energy storage element 15 in a rocker element 8. The structure is similar to FIG. 6. In contrast to the exemplary embodiment shown in FIG. 6, both rocker-side roller tracks 13 are pretensioned against the respective rollers 11,12 by a central second energy storage element 15. This may allow for a small installation space requirement and, if necessary, a suitable influence on the mass or center of gravity (cf. FIG. 1) of the relevant rocker element 8.

FIG. 8 shows a schematic diagram of the roller tracks 13,14 of a pendulum rocker damper 1 (for example according to FIG. 1) in an embodiment with a soft roller track 13,14. In contrast to the exemplary embodiment shown in FIG. 6, the rocker-side roller track 13 is designed to be soft. The second pretensioning force 16 of the second energy storage element 15 (represented here by a plurality of compression springs) is transmitted almost directly to the roller 11 in this exemplary embodiment. Due to the plurality of compression springs, which can also be understood as infinitesimally small sections of the roller track 13,14, a stiffness dependent on the torsion angle 17 can be set.

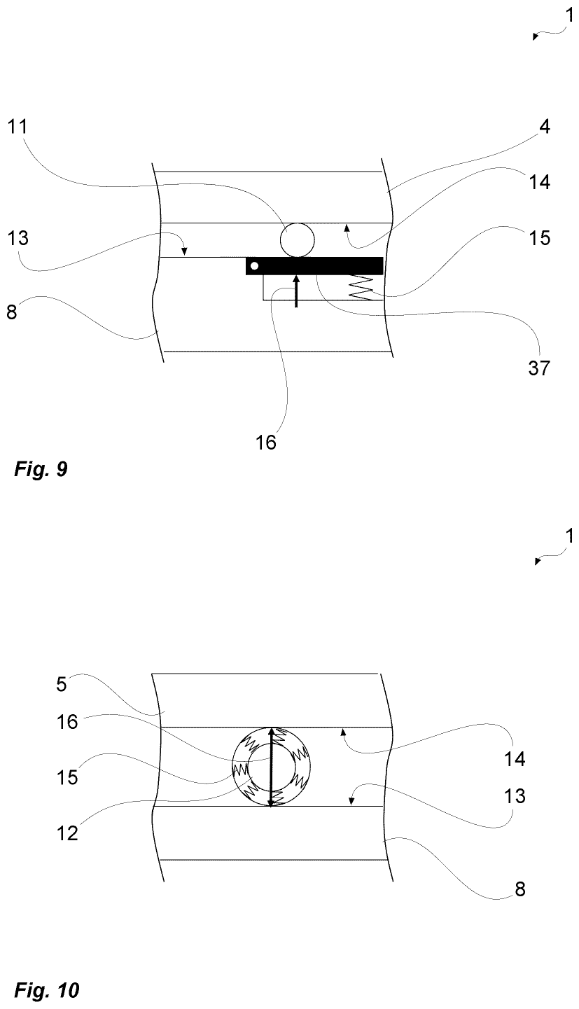

FIG. 9 shows a schematic diagram of the roller tracks 13,14 of a pendulum rocker damper 1 (for example according to FIG. 1) in an embodiment with a roller 11 pretensioned in a locally limited manner. In contrast to the exemplary embodiments shown in FIGS. 5 to 8, the rocker-side roller track 13 is formed in one section by a separate (for example, rigid) element, and the separate element is movably connected to the remaining roller track 13 and is pretensioned towards the complementary (here outer) roller track 14 by means of a second energy storage element 15 (here represented by a compression spring). The second pretensioning force 16 applied to the secondary roller 12 by means of the second energy storage element 15 and the separate element is therefore locally limited in this exemplary embodiment, as well as transmitted to the rocker-side roller track 13 (purely optionally) in a variable manner depending on the torsion angle 17. In an actual embodiment, the element is, for example, formed by a cantilever 37, preferably made of a spring steel (not rigid, in that case).

FIG. 10 shows a schematic diagram of an (optionally secondary) roller 12 with a second energy storage element 15 between the roller tracks 13,14 of a pendulum rocker damper 1 (for example according to FIG. 1). In this exemplary embodiment, the roller 12 is designed in such a way that it is surrounded by the second energy storage element 15 (here purely optionally in a circumferential manner). Due to the symmetrical arrangement of the second energy storage element 15, the roller 12 is spring-loaded against both the rocker-side roller track 13 and the outer roller track 14 by means of the second pretensioning force 16. Thus the roller 12 (with a constant distance between the outer roller track 14 and the rocker-side roller track 13) is also pretensioned against both roller tracks 13,14 outside of the resting position.

In this exemplary embodiment, the roller 12 is designed to be rigid, for example made of a tool steel, and the circumferential second energy storage element 15 is also designed to be rigid, for example as a spring plate, which is supported on the roller 12 in an actual implementation in the manner of a corrugated spring, for example, or is formed by a (for example injection-molded) plastic. It should be noted that this exemplary embodiment can alternatively or in addition also be implemented with a primary roller 11. If only one of the rollers 11,12 is designed in this way, the resulting second pretensioning force 16 may be sufficient for the respectively other roller 12,11. This also applies analogously to the other exemplary embodiments shown.

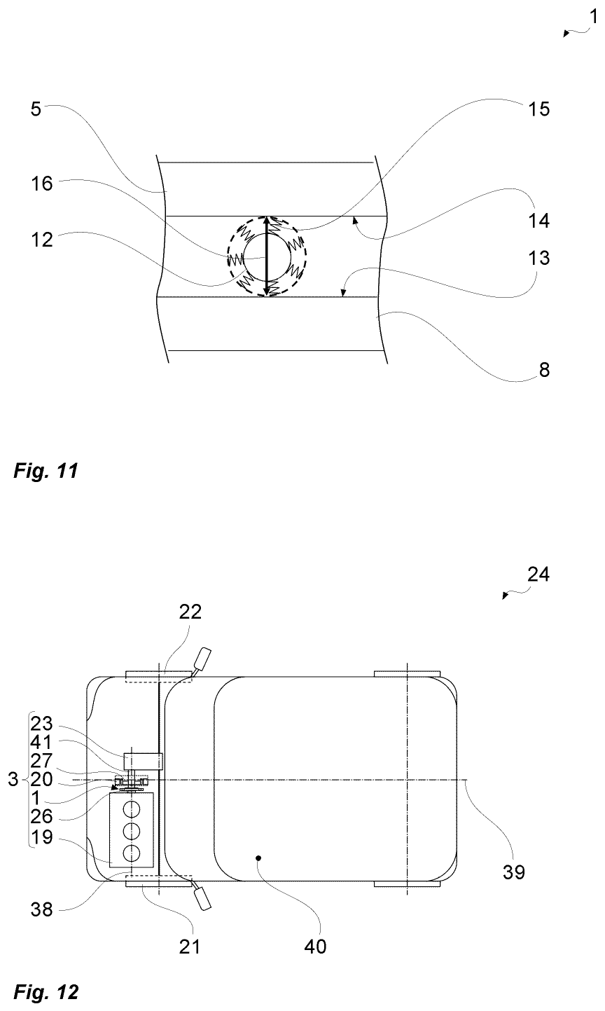

FIG. 11 shows a schematic diagram of a roller 11 with a second energy storage element 15 between the roller tracks 13,14 of a pendulum rocker damper 1 in an alternative embodiment to the embodiment according to FIG. 10. In contrast to the exemplary embodiment in FIG. 10, the roller 12 and the second energy storage element 15 are formed integrally and are designed to be elastic overall. For example, the second energy storage element 15 or the roller 12 is designed as an elastomer. Thus, the second pretensioning force 16 is applied in such a way that the roller 12 is pretensioned both against the rocker-side roller track 13 and against the outer roller track 14, and the roller 12 is subjected to a reversible deformation in the process.

In FIG. 12, a motor vehicle 24 with a drive train 3 is shown schematically in a top view. A first drive machine 19, for example an internal combustion engine 19, with its internal combustion engine shaft 26 and, purely optionally, a second drive machine 20, for example an electric drive machine 20, with a rotor shaft 27 are arranged in a transverse front arrangement along the motor axis 38 and transversely to the longitudinal axis 39 and in front of the driver's cab 40 of the motor vehicle 24. This concept is referred to as a hybrid drive. The electric drive machine 20 is arranged coaxially to a pendulum rocker damper 1 according to FIG. 1 and a separating clutch here. The drive train 3 is configured to propel the motor vehicle 24 by driving a left-hand drive wheel 21 and a right-hand drive wheel 22 (here optionally of the front axle of the motor vehicle 24) by means of a torque output from at least one of the drive machines 19,20. The torque transmission from the internal combustion engine 19 (and in a corresponding configuration, for example P2, also from the electric drive machine 20) can be interrupted by means of the separating clutch and rotational irregularities of the internal combustion engine 19 are reduced early on in the drive train 3 by means of the pendulum rocker damper 1.

The rotor shaft 27 is permanently connected (or can be disconnected with a further torque clutch not shown) to a transmission 23, which is designed, for example, as a continuously variable transmission. A master system, for example a clutch pedal in the driver's cab 40 with a master cylinder, is provided for the purely optional hydraulic actuation of the separating clutch, and the master system is connected to the slave system in a communicating manner via the transmission input shaft 41, which is connected during operation. The actuation of the separating clutch is often subject to the control scheme of an automated manual transmission [AMT] and/or a hybrid drive train, wherein carbon dioxide emissions are prioritized, for example.

The pendulum rocker damper proposed here can be used to reduce disruptive noises and also reliably prevent a roller from sliding by shifting the natural frequency into non-critical ranges. The second energy storage element 15 is provided in the roller 11,12 or in at least one of the roller tracks 13, 14 for exerting a second pretensioning force 16, and the roller 11,12 is pretensioned against at least one of the roller tracks 13,14, perpendicular to the track, at least in the resting position of the first energy storage element 9, using the second pretensioning force 16.

### REFERENCE NUMERALS

1 Pendulum rocker damper
2 Axis of rotation
3 Drive train
4 Primary side
5 Secondary side
6 Primary outer connection
7 Secondary outer connection
8 Rocker element
9 First energy storage element
10 First pretensioning force
11 Primary roller
12 Secondary roller
13 Rocker-side roller track
14 Outer roller track
15 Second energy storage element
16 Second pretensioning force
17 Torsion angle
18 Additional mass
19 Internal combustion engine
20 Electric drive machine
21 Left drive wheel
22 Right drive wheel
23 Transmission
24 Motor vehicle
25 Hub
26 Internal combustion engine shaft
27 Rotor shaft
28 First direction of rotation
29 Second direction of rotation
30 First roller direction of rotation
31 Second roller direction of rotation
32 Excitation frequency
33 Force on rollers
34 Upper contact force of the rollers
35 Lower contact force of the rollers
36 Average value of the contact force of the rollers
37 Cantilever
38 Motor axis
39 Longitudinal axis
40 Driver's cab
41 Transmission input shaft

1. A pendulum rocker damper with an axis of rotation for a drive train, having at least the following components:
a primary side that is connected in a torque-transmitting manner to a first outer connection;
at least one rocker element;
at least one first energy storage element for exerting a first pretensioning force;
at least one roller; and
a secondary side that is connected in a torque-transmitting manner to a second outer connection,
wherein the at least one roller is mounted such that it can roll on a rocker-side roller track and an outer roller track that is complementary to the rocker-side roller track and is pretensioned against the roller tracks by means of the first pretensioning force of the at least one first energy storage element,
wherein at least one second energy storage element is provided in the roller or in at least one of the roller tracks for exerting a second pretensioning force, and
wherein the roller is pretensioned against at least one of the roller tracks, perpendicular to the track, by means of the second pretensioning force, at least in a resting position of the first energy storage element.

2. The pendulum rocker damper according to claim 1, wherein:
the second pretensioning force is exerted on an associated roller by means of at least one roller track, and
the roller track has a stiffer material than the second energy storage element.

3. The pendulum rocker damper according to claim 2, wherein:
the rocker element is supported on the primary side and on the secondary side by means of at least one roller in each case, and the second energy storage element is arranged between the rocker-side roller tracks in order to exert the second pretensioning force on the rollers in each case.

4. The pendulum rocker damper according to claim 1, wherein:
the second pretensioning force of the second energy storage element has a spring stiffness that is variable depending on a torsion angle between the primary side and the secondary side.

5. The pendulum rocker damper according to claim 1, wherein:
at least one of the second energy storage elements is comprised by one of the rollers, and
each of the rollers comprises one of the second energy storage elements.

6. The pendulum rocker damper according to claim 1, wherein;
at least one of the second energy storage elements is arranged to exert the second pretensioning force in a locally limited manner on an associated roller.

7. The pendulum rocker damper according to claim 1, wherein:
the rocker element comprises an additional mass for shifting its center of gravity.

8. A drive train, having at least the following components:
at least one drive machine for outputting a torque;
at least one consumer for receiving a torque;
a transmission for transmitting a torque between the at least one drive machine and a consumer; and
a pendulum rocker damper according to claim 1, wherein:
a torque can be transmitted in a modulated manner between the at least one drive machine and the consumer by means of the pendulum rocker damper.

9. A motor vehicle, having a drive train according to claim 8 and at least one drive wheel, wherein the at least one drive wheel can be driven by means of the drive train in order to propel the motor vehicle.

10. A pendulum rocker damper for a drive train comprising:
an axis of rotation;
a first outer connection;
a primary side connected to the first outer connection in a torque transmitting manner;
a second outer connection;
a secondary side connected to the second outer connection in a torque transmitting manner;
a rocker element;
a rocker-side roller track;
an outer roller track complementary to the rocker-side roller track;
a roller arranged to roll on the rocker-side roller track and the outer roller track;
a first energy storage element arranged to pretension the roller against the rocker-side roller track and the outer roller track;
a second energy storage element arranged in the roller, or in the rocker-side roller track or the outer roller track, and arranged to pretension the roller against one of the rocker-side roller track or the outer roller track in a direction perpendicular to the one of the rocker-side roller track or the outer roller track when the first energy storage element is in a resting position.

11. The pendulum rocker damper of claim 10, wherein the one of the rocker-side roller track or the outer roller track pretensions the roller.

12. The pendulum rocker damper of claim 11 wherein the one of the rocker-side roller track or the outer roller track is stiffer than the second energy storage element.

13. The pendulum rocker damper of claim 10 wherein each of the primary side and the secondary side comprises respective ones of the rocker-side roller track, the outer roller track, the roller and the second energy storage element.

14. The pendulum rocker damper of claim 10 wherein a spring stiffness of the second energy storage element depends on a torsion angle measured between the primary side and the secondary side.

15. The pendulum rocker damper of claim 10 wherein the second energy storage element is arranged in the roller.

16. The pendulum rocker damper of claim 10 wherein the rocker element comprises an additional mass that adjusts a rotating inertia of the rocker element.
